(19) United States
(12) Patent Application Publication
(10) Pub. No.: US 2012/0321072 A1
(43) Pub. Date: Dec. 20, 2012

(54) ROUTING OF CONTACTS IN CONTACT CENTERS

(75) Inventors: Enda Dooley, Galway (IE); Peter Flannery, Galway (IE); Hugh Tynan, Galway (IE); Padraic Walsh, Galway (IE); David Saunders, Galway (IE)

(73) Assignee: AVAYA INC., Basking Ridge, NJ (US)

(21) Appl. No.: 13/163,772

(22) Filed: Jun. 20, 2011

(51) Int. Cl. H04M 3/00

(52) U.S. Cl. 379/265.12

(57) ABSTRACT

Contacts are routed to contact center agents handling multiple concurrent contacts by determining, for each of a plurality of agents, a historical average measure of time taken by that agent to handle one more contact than they are currently handling, and making a routing decision which is at least partially based on this historical average measure of time.

### BACKGROUND

1. Field of the Invention

This invention relates to the routing of contacts within contact centers.

2. Description of Related Art

Contact centers (also referred to as call centers) have traditionally routed calls or other contact types (instant messages, video calls, etc.) to agents one at a time. Thus each agent is either busy or idle, and routing algorithms exist to route a contact to the agent who has been longest idle (for example) or to the next available agent, if all are busy.

More recently, as customers employ channels other than telephone calls to make contact with a contact center, a trend has developed for agents to handle multiple contacts at once. This feature is referred to herein as “multiplicity” and is most typically employed to assign simultaneous multiple contacts to an agent, such as instant messages (IMs), emails, scanned documents (including regular mail and faxes), SMS text messages or web form submissions. Multiplicity settings may allow the agent to handle such multimedia contacts at the same time as voice and video calls, or agents may be restricted either to voice or to multimedia. An example of a system allowing multiplicity is described in commonly assigned U.S. Pat. No. 7,746,362, the entire content of which is incorporated herein by reference.

In the Avaya Aura Contact Center (“Avaya” and “Aura” are trademarks of Avaya Inc. of Basking Ridge, N.J.), the multiplicity feature is configured and assigned to agents using Multiplicity Presentation Class (MPC) in Contact Center Manager Administration (CCMA). A MPC is a collection of multiplicity configuration options. MPC configuration options include the following:
maximum number of concurrent contacts the agent can handle;
time to wait before presenting the next contact to the agent;
check box to allow presentation of a voice call while working on multimedia contacts;
check box to allow presentation of multimedia contact while active on a voice call;
maximum number of contacts that can be presented for each contact type; and
maximum number of contacts that can be presented for individual skillsets.

Currently in this Avaya product, the maximum number of concurrent contacts that an agent can be assigned is five.

Not all agents will be equally good at the multi-tasking and attention splitting required for handling multiple simultaneous contacts. While it is possible to assign different maximum numbers of contacts for different agents, or to assign certain agents a maximum concurrent number of one, the routing algorithms employed do not otherwise discriminate between agents who are better or worse at handling multiple contacts. Thus, if every agent is allowed to handle up to five contacts, for instance, contacts will be assigned to each agent using conventional routing decisions (longest idle agent, routing by skillset, round robin assignment of contacts etc.), until all agents have five contacts assigned to them.

### SUMMARY

The invention provides a method of routing a contact within a contact center to an agent of the contact center, comprising the steps of:

(a) determining, for each of the plurality of agents, a historical average measure of time taken for that agent to handle N+1 contacts, where the number of contacts currently being handled by that agent is N; and

(b) making a routing decision to route the contact to one of said plurality of agents, said routing decision being based at least partially on said determined historical average measure of time taken by said one of said plurality of agents to handle N+1 contacts.

It can be seen the method does not blindly assign a contact to whichever agent is least busy, or if several agents are deemed equally busy, in a round robin fashion. Instead, an evaluation is made as to the impact of the new contact on each of a number of agents, in order that the routing decision can take into account how this additional contact is expected to impact the handling time for not only the new contact but also the current contacts being serviced by the agents.

Preferably, the method further comprises the initial step of selecting said plurality of agents from among a larger group of contact center agents.

This initial step of selecting may involve determining one or more skillset(s) required to handle the contact and selecting the agents equipped with those skillset(s). It may involve selecting agents grouped together to collectively handle a particular queue. It may involve selecting only those agents enabled for multiplicity. It may involve selecting only those agents for whom the number of contacts currently being handled is below a particular threshold (e.g. only the equally least busy agents, or only the agents with three or fewer contacts etc.). And it may involve any combination of these selection criteria or any other criteria based on operational requirements.

The step of determining the historical average measure of time for an agent to handle N+1 contacts may comprise calculating the average in real time, or it may involve maintaining for all agents a record of the average time taken to handle different numbers of contacts and looking up this record as required.

Preferably, the historical average measure of time is calculated over a predefined period (such as the last day, week or month) to take account of fluctuations in agent performance and improvements by individual agents as they become more adept at handling multiple contacts.

Optionally, where agents handle contacts representing multiple types of media, the historical measure of time is calculated for a limited number of media types. Thus, for example, where the new contact to be routed is an instant messaging contact, the algorithm may look only to the historical measure of time taken by agents to handle N+1 contacts where one of the contacts is an instant messaging contact. Alternatively, for example, particular agents might be confined to handling (say) only emails and scanned documents, and the evaluation of handling times for N+1 contacts in such cases may be limited to the historical average for those agents when handling only those contact types.

An even more sophisticated determination of average historical measure of time to handle N+1 contacts will evaluate, for each agent, the current mix of media types in the N current contacts for that agent and will determine the historical average for the same mix of media types plus the media type for the new contact. In this way, an agent whose performance is generally good when handling (say) multiple IM and SMS contacts may be found to suffer a significant performance drop if a voice call is added to the mix of media types, and the algorithm can evaluate this by looking at the performance of each agent when confronted with their current mix of media types plus a voice call.

Since most contact centers will maintain detailed and granular records of agent performance with every contact, it is possible to dynamically maintain (or calculate on the fly) a table of all possible media mixes for that agent.

It is also possible for the historical average measure of time to be adjusted to take into account the time actually spent to date on the current N contacts being serviced by an agent. For example, it may be the case that sales agents in an outbound campaign have a time-per-contact distribution with two peaks, representing either a relatively short period of time spent with customers who indicate that they are not interested in the offer, and a relatively much longer period of time spent with those customers who wish to hear details of the offer and perhaps ultimately make a purchase. Where an agent has already spent more than a minimum amount of time with a customer and the conversation is still in progress, this may be indicative that the customer is in the subgroup of customers who may make a purchase. As a result the calculation of the average historical measure of time may be based on the data set of contact with customers in the potential purchase subgroup, affecting the likely amount of time that will be spent if a new contact is assigned to that agent.

The historical time average may also take into account other relevant characteristics of the contacts currently being handled by each agent as well as the new contact, such as the effect of higher priority contacts, or contacts relating to different skillsets or languages. In this way, more accurate predictions can again be made by comparing like with like.

Preferably, the step of making a routing decision is based on additional factors as well as the historical average measure of time taken by each of the agents to handle an additional contact. In this way, the business needs of the contact center can be catered for and more sophisticated routing decisions can be made based on the totality of information available about the contact and about the agents on duty.

The method is preferably a computer-implemented method carried out on a suitably programmed computer system. The computer system may be a stand-alone computer or may be distributed, and the method steps can be carried out by a single piece of software or a number of software modules working together. The computer system preferably has access to a storage area which stores historical details of the time taken by individual agents to handle contacts, or is in communication with a statistical program which calculates the historical average times and communicates these to the computer system as required.

Accordingly there is also provided a computer program product comprising a tangible storage medium encoding instructions, which when executed in a computer system of a contact center cause the computer system to:

(a) determine, for each of a plurality of agents of the contact center, a historical average measure of time taken for that agent to handle N+1 contacts, where the number of contacts currently being handled by that agent is N; and

(b) make a routing decision to route the contact to one of said plurality of agents, said routing decision being based at least partially on said historical average measure of time taken by each of the agents to handle an additional contact.

There is also provided a contact center routing system for routing a contact within a contact center to an agent of the contact center, comprising:

(a) a processor programmed to calculate, for each of a plurality of agents, a historical average measure of time taken for that agent to handle N+1 contacts, where the number of contacts currently being handled by that agent is N; and

(b) a routing engine adapted to route the contact to one of said plurality of agents, said routing being based at least partially on said historical average measure of time taken by each of the agents to handle an additional contact as calculated by said processor.

### BRIEF DESCRIPTION OF THE DRAWINGS

The invention will now be further illustrated by the following description of embodiments thereof given by way of example only with reference to the accompanying drawings, in which:

FIG. 1 is a system architecture of a contact center connected to customers via a network;

FIG. 2 is a flowchart detailing a first routing algorithm; and

FIG. 3 is a flowchart detailing a second routing algorithm.

### DETAILED DESCRIPTION

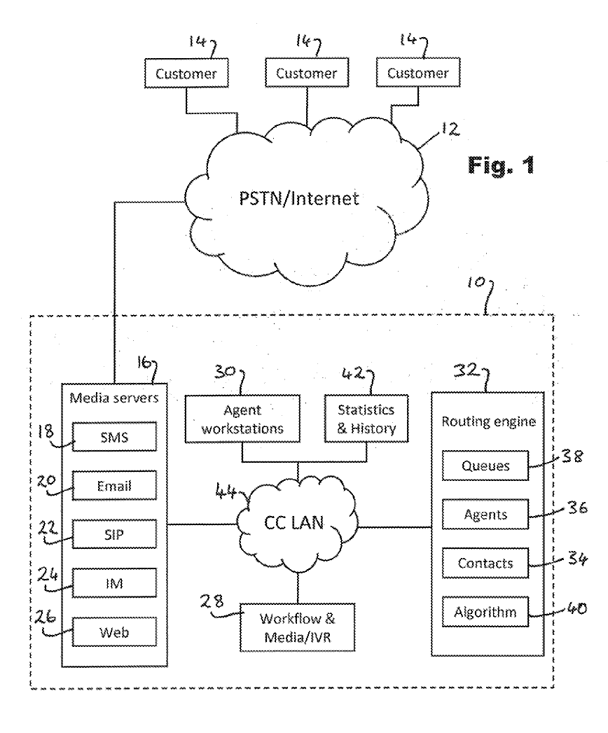

In FIG. 1 there is shown a contact center 10 connected to public communications networks such as the public switched telephone network (PSTN) and Internet 12. Customers 14 may connect to the contact center 10 in known manner, either as inbound calls to the contact center or outbound calls from the contact center. Various different media types may be used to connect such as by voice and video calls, emails, instant messaging (IM), by web submissions and so forth. A plurality of media servers 16 are provided in the contact center 10 to handle such contacts, including a short message service (SMS) server 18 to handle text messages, email server 20, a session initiation protocol (SIP) server 22 to handle voice calls, an IM server 24 to handle instant messaging and chat services, and a web server 26. Other arrangements are also possible to cater for the same or different media types in known manner, or to take account of new technologies and protocols. For example, the SIP server could be replaced with a standard PBX or any other telephony switch or server, and the same is true for each other component for which alternative technologies exist. For example there may also be a fax server and a document management system for handling scanned paper communications.

Communications sessions and other contacts received at the media servers 16 are handled in accordance with predefined workflows and optionally submitted to various media treatments such as interactive voice response (for voice calls) or automated scripts (for emails, instant messages and web contacts), and such workflows are handled by a workflow and media/IVR system 28, again in known fashion. In general, unless a contact is disposed of by automated treatment, it will need to be routed to a human agent at a workstation 30 for handling. Typical contact centers will have hundreds of such agent workstations, either on-site or connected remotely (e.g. home agents).

In order to route contacts to agents and to manage the handling of the contacts generally, a routing engine 32 is provided which maintains, for each communication or contact a contact record 34 in which all relevant information required to route the contact is kept. Similarly, for each agent, an agent record 36 is maintained with the agent's status, current contact assignments, skill sets and so on. In the contact center shown, a number of queues 38 are maintained, with contacts being assigned to one or more queues based on priority, skillset, media type and other relevant factors in order that a competent agent may be assigned to service the contact (or may select the contact from the queue), and in order that contacts are handled as efficiently as possible given their requirements and expectations and the available resources at the contact center.

Routing decisions are made in accordance with one or more routing algorithms 40 which attempt to assign contacts to relevant agents based on known information and the resources currently available, as well as the business needs of the contact center.

A statistics and history server 42 is provided with a feed of all relevant events occurring at the contact center, such as contacts connecting and disconnecting, agents becoming available and unavailable, contacts being assigned to agents, sales made to customers by agents, and so on. In known manner this information is stored, categorized and analyzed to allow better management of the contact center. In particular within the context of this invention, a historical record is kept of the time taken by each agent to complete each contact session, and from this historical averages of completion times are maintained, which may be broken down further to provide figures based on contact media type, priority and so on.

Communication between the various components of the contact center occurs over a contact center local area network (LAN) 44 using conventional protocols and technology. In the event that any of the components are co-resident on a single system such as a server incorporating several of the functions, then it is to be understood that connection between such components over a LAN would be redundant.

It should be noted that while the overview above is described mostly in terms of inbound contacts, the contact center will typically also deal with outbound campaigns, either by assigning particular agents with a feed of outbound communications (e.g. by a predictive dialler) or by mixing inbound and outbound contacts, which can be done by representing outbound communications as contacts which are queued and assigned to agents by the routing algorithms 40.

The above description is of a conventional contact center and it will be appreciated that only the details relevant to the present invention are described. The skilled person will be aware that a real contact center will have a far greater degree of complexity, but for simplicity such details are omitted here but will be readily apparent to one of skill in the art.

The contact center 10 is enabled for multiplicity, in that the routing algorithms 40 allow (and indeed enforce) the assignment of multiple concurrent contacts to a single agent according to predefined constraints as described earlier. As will now be described however, the routing algorithms are modified in order to take account of the ability of different agents to efficiently handle multiple simultaneous contacts, and in order to assist in assigning a new contact to the agent who is likely to be most efficient in handling that contact in the context of those contacts already assigned.

The agent records 36 keep track of which contacts are currently being serviced by each agent, and this can be done by having a single agent record per agent which notes all details of all contacts being serviced by that agent, or by a separate record for each agent-contact instance. Either way, the information can be summarised in a table such as Table 1 below, which shows a simplified representation of how a group of five agents might currently be occupied.

TABLE 1

| | | | Time per |
|---|---|---|---|
| | Current | Number of | contact for |
| Agent ID | contacts | contacts N | N + 1 |
| Agent 1 | SMS3443 | 3 | 00:03:14 |
| | IM1220 | | |
| | Email796 | | |
| Agent 2 | IM1213 | 3 | 00:05:43 |
| | IM1216 | | |
| | Email802 | | |
| Agent 3 | Web555 | 4 | 00:02:59 |
| | IM1219 | | |
| | IM1227 | | |
| | Email854 | | |
| Agent 4 | Web551 | 4 | 00:05:30 |
| | IM1211 | | |
| | IM1224 | | |
| | SMS3400 | | |
| Agent 5 | Email804 | 3 | 00:03:37 |
| | Email811 | | |
| | SMS3429 | | |

It can be seen that agents 1, 2 and 5 have N=3 current contacts and agents 3 and 4 have N=4 current contacts. For each agent, the right-most column records the average historical measure of time for that agent per contact when dealing with N+1 contacts, i.e. the average for agents 1, 2 and 5 when dealing with 4 contacts, and for agents 3 and 4 when dealing with 5 contacts.

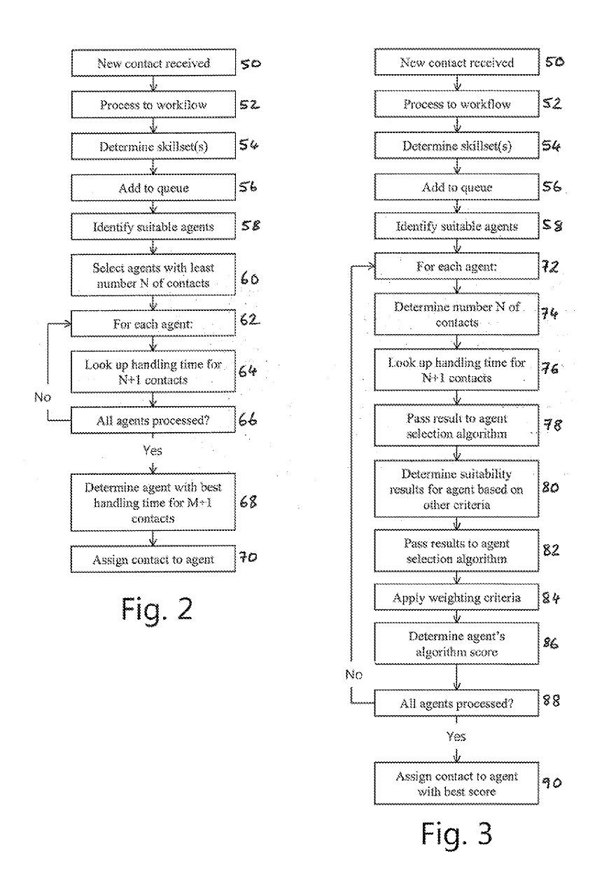

Referring additionally to FIG. 2, a flowchart is shown of a routing algorithm which may be used.

A new contact is received in step 50, which is processed through a workflow in the normal way, step 52 to determine required agent skillset(s), step 54, before being added to a queue, step 56. When the contact reaches or nears the top of the queue, suitable potential agents to service that contact from the queue are identified, step 58. For the purposes of illustration, we assume that the potential agents are agents 1-5 from Table 1.

In this algorithm, step 60 selects only the agent or agents with the fewest number of current contacts. This will be agents 1, 2 and 5 in this example. There is then a recursive check for each agent, beginning a loop at step 62, to look up from Table 1 (or some other data source available to the algorithm such as the statistics and history unit 42 (FIG. 1)) the historical average handling time for that agent to handle one more contact, i.e. 4 contacts, step 64. The calculation can also be done in real time when processing the algorithm, depending on the processing power available, the amount of data to be analysed and other system design considerations.

It can be seen from Table 1 that agent 1 has an indicated historical average time per contact of 3 minutes 14 seconds when working on four contacts simultaneously, as against 5 minutes 43 seconds for agent 2, and 3 minutes 37 seconds for agent 5.

When all agents have been processed to determine the historical average times in this way, step 66, the agent with the best (lowest) handling time for 4 contacts is determined and selected, step 68, and the contact is then assigned to that agent, step 70. The assignment of a contact to an agent may of course be constrained by other factors, such as the minimum time between successive contacts or the maximum number of allowed contacts per agent as described previously. Normally such checks are made back at step 58 when identifying which agents to regard as suitable for receiving the new contact.

FIG. 3 shows an alternative flowchart, which is generally similar between steps 50 and 58, which are numbered identically. In step 72 a programming loop begins for each agent, in which the number N of contacts is evaluated, step 74. This number is recorded in table 1 and is not the same for all five agents. Then the handling time is looked up (or calculated) for each agent, step 76, i.e. the historical average measure of time per contact for handling 4 contacts (agents 1, 2 and 5) or 5 contacts (agents 3 and 4). The results, showing that agent 3 has a historical average time of 2 minutes 59 seconds and agent 4 has a time of 5 minutes 30 seconds, along with the times previously noted for the other agents, are stored for use by the agent selection algorithm, step 78.

Instead of using this ranking of agent 3 as the sole basis for decision making, in step 80 other criteria are evaluated to determine suitability for handling the new contact. Any number of factors can be used here, such as skillset proficiency and matching, agent-customer history, priority, and so forth. The results of these additional determinations are also passed to the agent selection algorithm, step 82. Weighting factors may then be applied to the various factors, including the historical average measure of time determination, step 84, to arrive at a score for each agent, step 86. If all agents have not been processed, step 88, the process reverts back to step 72 until all agents have been processed, at which points the contact is assigned to the agent with the best score, step 90.

The differences between FIGS. 2 and 3 are simply two examples of how the historical average measure of time may be employed. For example, it would be possible to alter FIG. 2 so that all agents are evaluated, not just those with the fewest number of contacts, and to continue assigning contacts to the agent with the lowest measure of time, regardless of an imbalance between the numbers of contacts per agent, such that the new contact might be awarded to agent 3 even though that agent would then have five contacts while others had only three.

A further variation is illustrated with reference to Table 2 below.

TABLE 2

| | Current | | Time per contact where |
|---|---|---|---|
| Agent ID | contacts | N | contact mix is |
| Agent 1 | SMS3443 | 3 | 1 SMS + 2 IM + 1 Email |
| | IM1220 | | 00:05:15 |
| | Email796 | | |
| Agent 2 | IM1213 | 3 | 3 IM + 1 email |
| | IM1216 | | 00:05:45 |
| | Email802 | | |
| Agent 3 | Web555 | 4 | 1 Web + 3 IM + 1 Email |
| | IM1219 | | 00:03:19 |
| | IM1227 | | |
| | Email854 | | |
| Agent 4 | Web551 | 4 | 1 Web + 3 IM + 1 SMS |
| | IM1211 | | 00:06:44 |
| | IM1224 | | |
| | SMS3400 | | |
| Agent 5 | Email804 | 3 | 2 Email + 1 SMS + 1 IM |
| | Email811 | | 00:04:12 |
| | SMS3429 | | |

In this variation, the new contact to be allocated is an IM session. Rather than the blunt calculation of how long the average time spent per agent is affected by having e.g. 4 or 5 contacts generally, the calculation in the fourth column of Table 2 shows the historical average measure of time for a particular mix of media, i.e. the agent's current mix of contacts together with one additional IM session. It can be seen that using this more granular approach, the expected average times have gone up, due to the fact that historically in this contact center, instant messaging sessions require more agent time than some other media types such as SMS and emails, although there is still individual variation between agents so that agent 3 is far more efficient than agent 4.

By taking a more granular approach it can be seen that when comparing agents 1, 2 and 5, such as by employing the flowchart of FIG. 2, agent 5 is now expected to have the lowest average time per contact when confronted with a new IM session. If the flowchart of FIG. 3 is followed, comparing all five agents, agent 3 still has the lowest time, but as the times have changed for all five agents the weighting criteria in step 84 may lead to a different overall result in terms of each agent's algorithm score.

The invention is not limited to the described embodiments which may be modified without departing from the spirit and scope of the claimed invention.

What is claimed is:

1. A method of routing a contact within a contact center to an agent of the contact center, comprising the steps of:
(a) determining, for each of the plurality of agents, a historical average measure of time taken for that agent to handle N+1 contacts, where the number of contacts currently being handled by that agent is N; and
(b) making a routing decision to route the contact to one of said plurality of agents, said routing decision being based at least partially on said determined historical average measure of time taken by said one of said plurality of agents to handle N+1 contacts.

2. The method of claim 1, further comprising the initial step of selecting said plurality of agents from among a larger group of contact center agents.

3. The method of claim 2, wherein the initial step of selecting comprises determining one or more skillset(s) required to handle the contact and selecting agents equipped with those skillset(s).

4. The method of claim 2, wherein the initial step of selecting comprises selecting agents assigned to one or more queues.

5. The method of claim 2, wherein the initial step of selecting comprises selecting only those agents enabled to handle a plurality of contacts concurrently.

6. The method of claim 2, wherein the initial step of selecting comprises selecting only those agents for whom the number of contacts currently being handled is below a threshold.

7. The method of claim 1, wherein the step of determining the historical average measure of time for an agent to handle N+1 contacts comprises calculating the average in real time.

8. The method of claim 1, wherein the step of determining the historical average measure of time for an agent to handle N+1 contacts comprises maintaining for a plurality of agents a record of the average time taken to handle different numbers of contacts and consulting said record.

9. The method of claim 1, wherein said historical average measure of time is calculated over a predefined period.

10. The method of claim 1, wherein agents are enabled to handle contacts representing multiple types of media, and wherein the historical average measure of time taken by said one of said plurality of agents to handle N+1 contacts is based on the historic handling by that agent of contacts of a subset of media types.

11. The method of claim 1, wherein the average historical measure of time taken by said one of said plurality of agents to handle N+1 contacts is evaluated on the basis of the current mix of media types in the current N contacts handled by said one of said plurality of agents plus the media type for said contact to be routed.

12. The method of claim 1, wherein the historical average measure of time taken by said one of said plurality of agents to handle N+1 contacts includes at least one other relevant characteristic of one or more of said N contacts currently being handled by said agent or of said contact to be routed.

13. The method of claim 1, wherein the step of making a routing decision is based on additional factors as well as said historical average measure of time.

14. A computer program product comprising a tangible storage medium encoding instructions which when executed in a computer system of a contact center cause the computer system to:
(a) determine, for each of a plurality of agents of the contact center, a historical average measure of time taken for that agent to handle N+1 contacts, where the number of contacts currently being handled by that agent is N; and
(b) make a routing decision to route the contact to one of said plurality of agents, said routing decision being based at least partially on said historical average measure of time taken by each of the agents to handle an additional contact.

15. A contact center routing system for routing a contact within a contact center to an agent of the contact center, comprising:
(a) a processor programmed to calculate, for each of a plurality of agents, a historical average measure of time taken for that agent to handle N+1 contacts, where the number of contacts currently being handled by that agent is N; and
(b) a routing engine adapted to route the contact to one of said plurality of agents, said routing being based at least partially on said historical average measure of time taken by each of the agents to handle an additional contact as calculated by said processor.
